(19) United States
(12) Patent Application Publication
(10) Pub. No.: US 2016/0065679 A1
(43) Pub. Date: Mar. 3, 2016

(54) REGISTRATION OF DOCUMENT SERVICES PROVIDED BY AN ONLINE DOCUMENT MANAGEMENT SYSTEM

(71) Applicant: Sheldon Robertson, Boynton Beach, FL (US)

(72) Inventor: Sheldon Robertson, Boynton Beach, FL (US)

(73) Assignee: RICOH COMPANY, LTD., Tokyo (JP)

(21) Appl. No.: 14/549,841

(22) Filed: Nov. 21, 2014

Related U.S. Application Data
(60) Provisional application No. 62/042,648, filed on Aug. 27, 2014.

(51) Int. Cl. H04L 29/08; G06F 17/30; H04L 12/58; H04L 29/06

(52) U.S. Cl. CPC H04L 67/16; H04L 67/02; H04L 67/42; H04L 67/06; G06F 17/30887; H04L 51/36

(57) ABSTRACT

Embodiments describe registration of document services for a document management system. A server receives a request to register a service provided by the system, and generates an activation code for the service. The server identifies a web address for activating the service, and provides the web address and the code to a user. The server provides a first web page to the user that requests the code from the user. The server receives an entry via the first web page and determines if the entry matches the code. The server provides a second web page that identifies the service and includes an option to activate the service when the entry matches, and notifies the user of an error when the entry does not match. The server receives a request via the second web page to activate the service, and enables the service for the user at the system.

### CROSS REFERENCE TO RELATED APPLICATIONS

This document claims priority to, and thus the benefit of an earlier filing date from, U.S. Provisional Patent Application No. 62/042,648 (filed 27 Aug. 2014) entitled “AUTOMATION OF INDIRECT REGISTRATION FOR A WEB-BASED SERVICE”, which is hereby incorporated by reference.

### FIELD OF THE INVENTION

The invention relates to the field of online document management, and in particular, to registering document services provided by an online document management system.

### BACKGROUND

An online document management system allows users to store, access, and manage their documents remotely in the cloud. In addition to basic storage and retrieval services, the document management system may provide additional services to users such as the creation of custom document types, the assignment of metadata for documents, indexing of documents, Optical Character Recognition (OCR) services for documents, version control for documents, etc.

To allow a user to subscribe to a new service provided by the document management system, a customer order for the request is typically generated for a salesperson. The salesperson provides product codes and registration codes for the service to the user. The user is then tasked with manually entering in the product codes and configuring the service for use at the document management system. However, this process can be prone to errors, which can result in user frustration and calls to customer service for help, which is undesirable.

### SUMMARY

Embodiments describe automatic registration of document services for an online document management system. During the registration process for a service requested by a user, a link to a web page and registration information for the requested service is provided to the user, who then is able to perform the registration process online substantially independently.

In one embodiment, a processor of a server is configured to receive a request to register a document service provided by an online document management system for a user, and to generate an activation code for the service. The processor is further configured to identify a web address for activating the service, and to provide the web address and the activation code to the user. The processor is further configured to receive a request from a computing device of the user to display a web page for the web address, to provide a first web page to the computing device that includes an entry field requesting the activation code from the user, and to receive the entry via the first web page from the computing device. The processor is further configured to determine if the entry matches the activation code for the service, to provide a second web page to the computing device that identifies the service and includes an option to activate the service when the entry matches the activation code, and to notify the user of an error when the entry does not match the activation code. The processor is further configured to receive a request via the second web page to activate the service, and to enable the service for the user at the document management system.

Another embodiment is a method of automatic registration of document services for an online document management system. The method comprises receiving a request to register a document service provided by the document management system for a user, and generating an activation code for the service. The method further comprises identifying a web address for activating the service, and providing the web address and the activation code to the user. The method further comprises receiving a request from a computing device of the user to display a web page for the web address, and providing a first web page to the computing device that includes an entry field requesting the activation code from the user. The method further comprises receiving the entry via the first web page from the computing device, and determining if the entry matches the activation code for the service. The method further comprises providing a second web page to the computing device that identifies the service and includes an option to activate the service when the entry matches the activation code, and notifying the user of an error when the entry does not match the activation code. The method further comprises receiving a request via the second web page to activate the service, and enabling the service for the user at the document management system.

Another embodiment is a non-transitory computer readable medium embodying instructions which, when executed by a processor of a server, direct the processor to receive a request to register a document service provided by an online document management system for a user, to generate an activation code for the service, and to identify a web address for activating the service. The instructions further direct the processor to provide the web address and the activation code to the user, to receive a request from a computing device of the user to display a web page for the web address, and to provide a first web page to the computing device that includes an entry field requesting the activation code from the user. The instructions further direct the processor to receive the entry via the first web page from the computing device, to determine if the entry matches the activation code for the service, to provide a second web page to the computing device that identifies the service and includes an option to activate the service when the entry matches the activation code, and to notify the user of an error when the entry does not match the activation code. The instructions further direct the processor to receive a request via the second web page to activate the service, and to enable the service for the user at the document management system.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a document collaboration system in an exemplary embodiment.

FIG. 2 is a block diagram of the server of FIG. 1 in an exemplary embodiment.

FIG. 3 is a flowchart illustrating a method of automatic registration of a document services for online document management system in an exemplary embodiment.

FIG. 4 is a block diagram of another document collaboration system in an exemplary embodiment.

FIGS. 5-6 illustrate web pages for provisioning document services in exemplary embodiments.

FIGS. 7-8 illustrate web pages for activating document services in exemplary embodiments.

FIG. 9 is a block diagram of a processing system configured to execute programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

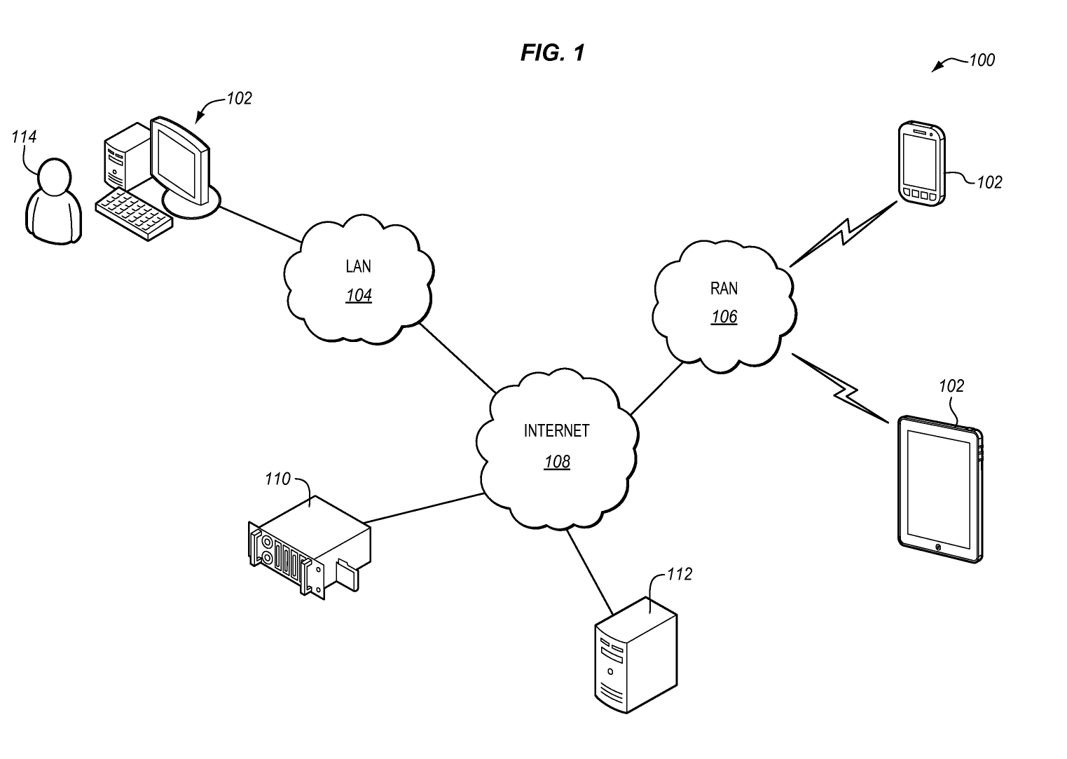

FIG. 1 is a block diagram of a document collaboration system 100 in an exemplary embodiment. In this embodiment, system 100 includes an online document management system 110, which is coupled to Internet 108 to allow computing devices 102 to participate in a collaborative document environment. In this embodiment, document management system 110 includes any component, system, or device that is able to remotely store and manage documents for computing devices 102. For example, document management system 110 may include one or more file servers that allow computing devices 102 to upload files to document management system 110, download files from document management system 110, check out files, lock files, etc. Document management system 110 may also be referred to as a cloud storage system or an online file management system and/or service.

In this embodiment, three computing devices 102 are illustrated, although the implementation of system 100 may include more or fewer computing devices 102 as an implementation choice. Also, system 100 is not necessarily limited to the particular computing devices 102 illustrated in FIG. 1. In FIG. 1, one of computing devices 102 comprises a computer, which is coupled to Internet 108 utilizing a Local Area Network (LAN) 104. One example of LAN 104 is Ethernet. Also in FIG, 1, another of computing devices 102 comprises a smartphone, which is coupled to Internet 108 using a Radio Access Network (RAN) 106. Some examples of RAN 106 include Wi-Fi networks, cellular networks such as a Global System for Mobile Communications (GSM) network, a Code Division Multiple Access (CDMA) network, etc. RAN 106 may be coupled with additional network elements to interface with Internet 108 (e.g., core network elements), not shown. Another one of computing devices 102 comprises a tablet computer, which also couples to Internet 108 using RAN 106.

System 100 in this embodiment includes a server 112, which is coupled to Internet 108 to allow computing devices 102 to participate in a registration and activation process for document services provided by document management system 110. In this regard, server 112 includes any component, system, or device that allows services provided by document management system 110 to be provisioned, activated, and/or enabled for users of document management system 110. For example, server 112 may provide web interfaces to a salesperson to provision new services for a user that are provided by document management system 110, may provide web interfaces to the user for validating and activating the requested services, etc.

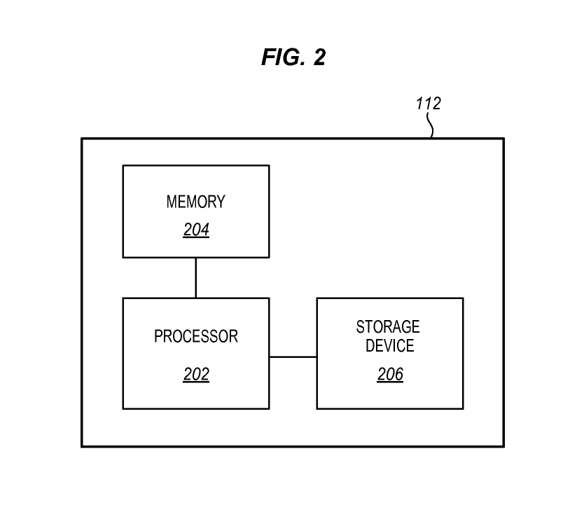

FIG. 2 is a block diagram of server 112 of FIG. 1 in an exemplary embodiment. In this embodiment, server 112 includes a processor 202, a memory 204, and a storage device 206. Processor 202 includes any hardware device that is able to perform functions. Processor 202 may include one or more Central Processing Units (CPU), microprocessors, Digital Signal Processors (DSPs), Application-specific Integrated Circuits (ASICs), etc. Some examples of processors include Intel® Core ™ processors, Advanced Risk Machines (ARM®) processors, etc.

Memory 204 includes any hardware device that is able to store temporary data. For instance, memory 204 may store temporary variables used to generate web pages during the provisioning and/or activation process for services provided by repository 110. Memory 206 may include one or more volatile or non-volatile Dynamic Random Access Memory (DRAM) devices, FLASH devices, volatile Static RAM devices, etc.

Storage device 206 includes any hardware device that is able to store persistent data. For instance, storage device 206 may store web pages for provisioning and/or activating services provided by document management system 110. Storage device 206 may include one or more Hard Disk Drives (HDD), FLASH drives, Solid State Disks (SSDs), non-volatile DRAM, non-volatile SRAM, etc. Some examples of non-volatile DRAM and SRAM include battery-backed DRAM and battery-backed SRAM.

For this embodiment, assume that computing device 102 has access to server 112. Also assume that a user 114 has requested a service provided by document management system 110 to be set up for use. For example, user 114 may be a subscriber of services provided by document management system 110, and may have requested changes to an existing service or the addition of new services to an account associated with user 114. Or, user 114 may be a new subscriber, requesting an initial service provided by document management system 110.

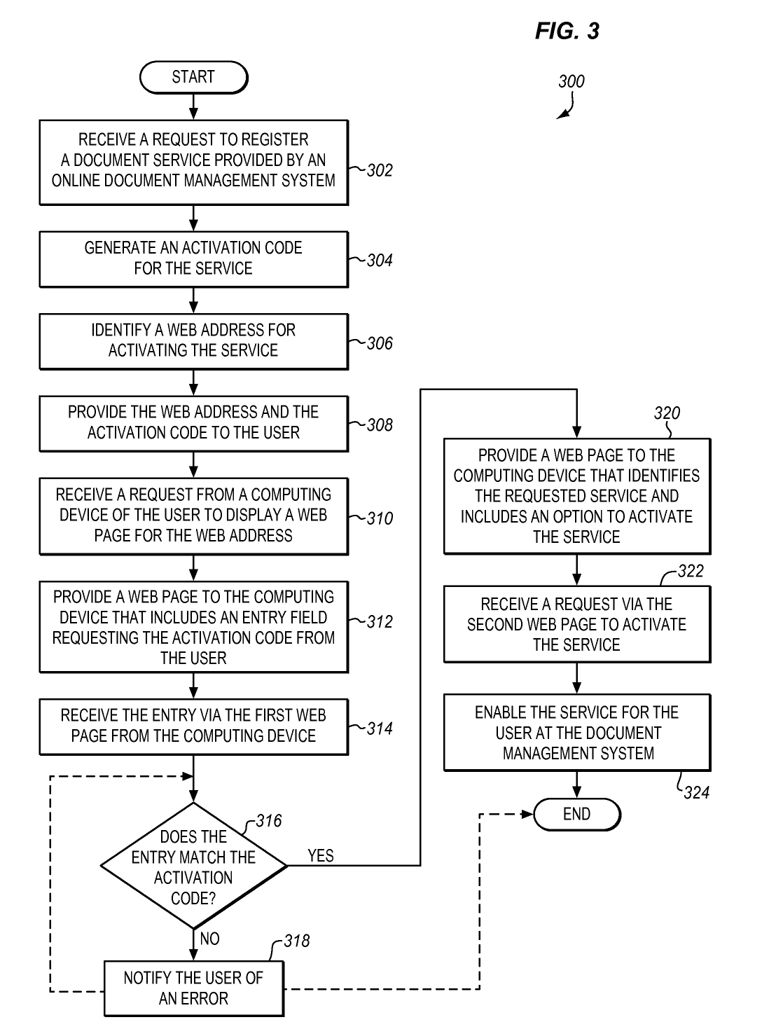

FIG. 3 is a flowchart illustrating a method 300 of automatic registration of document services for a document management system in an exemplary embodiment. The steps of method 300 will be described with reference to FIGS. 1-2, but those skilled in the art will appreciate that method 300 may be performed in other systems. The steps of the flowchart(s) described herein are not all inclusive and may include other steps not shown. The steps described herein may also be performed in an alternative order.

Processor 202 of server 112 receives a request to register a service provided by document management system 110 for user 114 (see step 302 of FIG. 3). For instance, a salesperson or administrative user may review sales order information of the services requested by user 114, and utilize a web application to generate the request. The request received by processor 202 may include an order number associated with the service requested by user 114, an account name for user 114, a product ID code for the service requested by user 114, etc. Some examples of services provided by document management system 110 include document storage, document management, online collaboration, version control, check-in and check-out of documents, document replication and backup, etc. In some embodiments, the request received by processor 202 for the service includes information such as an amount of storage requested by user 114, a number of concurrent users that may access an account for user 114, etc.

Processor 202 generates an activation code for the service requested by user 114 (see step 304). The activation code may be randomly generated, may be based on a hash table or other indicia associated with the particular service requested by user 114, etc.

Processor 202 identifies a web address for activating the service (see step 306). The web address may be a Uniform Resource Locator (URL) or other type of routable address across Internet 108 that can be reached by computing devices 102. For instance, the web address may resolve to a routable Internet Protocol (IP) address assigned to server 112. The web address may be an IP address, may be a domain name address that is convertible to the routable IP address assigned to server 112, etc.

Processor 202 provides the web address and the activation code to user 114 (see step 308). For instance, processor 202 may generate an email that includes the web address and the activation code, and transmit the email to an email account associated with user 114. Processor 202, for example, may generate a Short Message Service (SMS) (e.g., a text message) that includes the web address and the activation code, and transmit the SMS message to user 114. User 114 may then retrieve the web address and the activation code from the message. For instance, user 114 may receive an email with the web address, and utilize a browser (e.g., a HyperText Transport Protocol (HTTP)) compatible browser to display a web page associated with the web address.

Processor 202 receives a request from computing device 102 to display a web page for the web address (see step 310). The request may be, for instance, an HTTP request from a browser executing on computing device 102 to display the web page. Processor 202 provides the web page, which includes an entry field that requests the activation code from user 114 (see step 312). For instance, the web page may include a text field that user 114 may enter in the activation code that was previously received by user 114. The web page may include an active button or some other feature that allows user 114 to submit the activation code when the activation code has been entered. Processor 202 receives the entry from computing device 102 (see step 314). Processor 202 determines if the entry matches the activation code previously sent to user 114 (see step 316). If the entry does not match the activation code, then processor 202 notifies user 114 of the error (see step 318). Notifying user 114 of the error may include transmitting an email to user 114 regarding the error, transmitting a SMS message to user 114 regarding the error, displaying an error web page to user 114, etc.

If the entry matches the activation code for the service, then processor 202 provides a web page to user 114 that identifies the requested service and includes an option to activate the service (see step 320). By displaying the requested service to user 114 in the web page, user 114 is able to verify that the service has been configured correctly prior to activating the service. The web page may include, for instance, information regarding the storage size reserved for the service, the number of user that are allowed to use the service, whether various document management features have been configured for the service, etc., along with an active button or some other feature that allows user 114 to activate the service. Processor 202 receives the activation request from computing device 102 to activate the service, and enables the service for user 114 at document management system 110.

Utilizing method 300, services requested by users (e.g., user 114) of document management system 100 can be quickly and reliably configured, verified, and activated.

### EXAMPLE

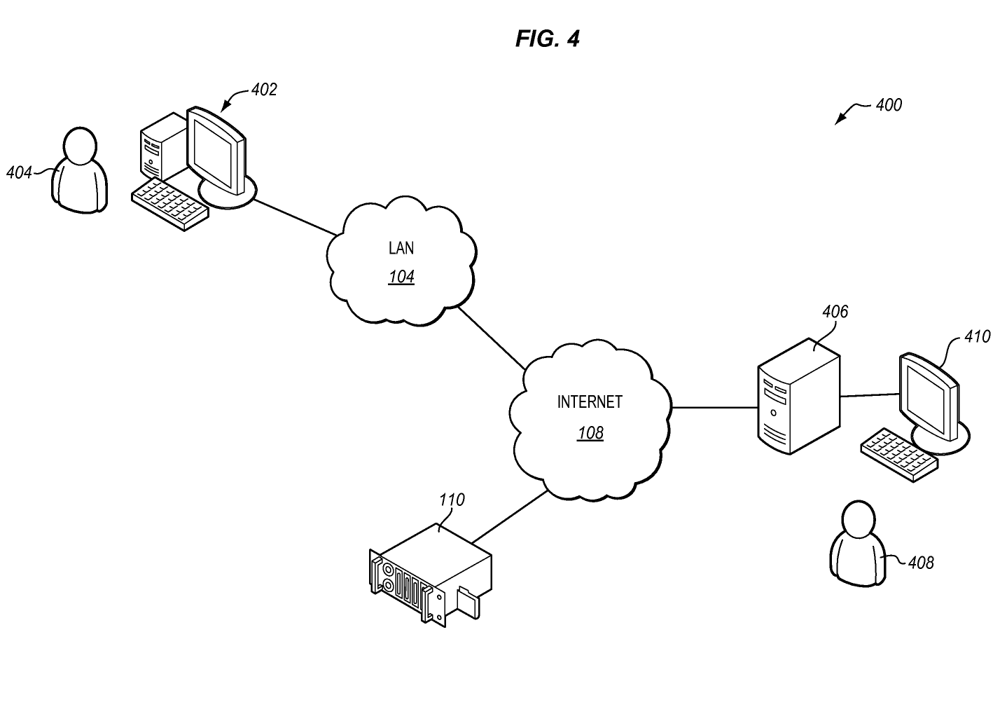

The following example will be discussed with respect to online collaboration system 400 of FIG. 4. The example is not intended to define a preferred embodiment or limit the scope of the claims but rather, is intended to provide one possible implementation of automatic registration of document services for a document management system.

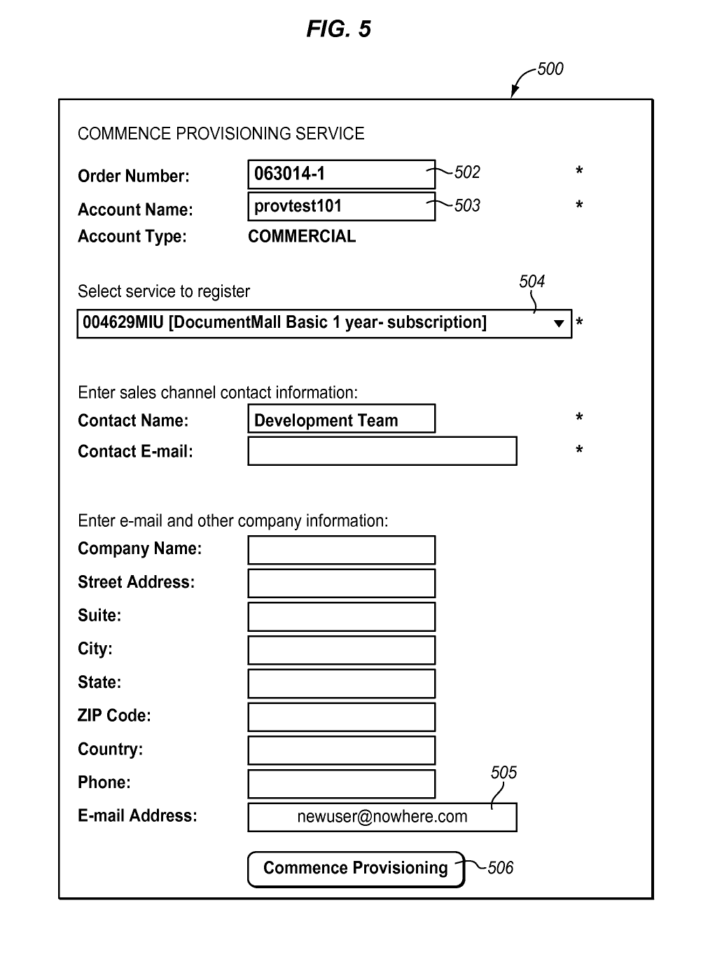

Assume for this embodiment that a salesperson 408 uses terminal 410 to launch an HTTP browser, which causes server 406 to display a web page on terminal 410 for provisioning document services. One example of a provisioning web page 500 is illustrated in FIG. 5. Salesperson 408 is able to review an order for user 404, and enter in an order number into field 502 of web page 500 for services requested by user 404. Salesperson 408 also enters in an account name into a field 503 associated with the order number. The account name may be a new account for user 404 or an existing account. Salesperson 408, via web page 500, selects a service from a drop down box 504 provided by document management system 110 that is being requested by user 404. Salesperson 408 then enters in an email address in field 505 for user 404, and begins the provisioning process for the service by selecting a button 506.

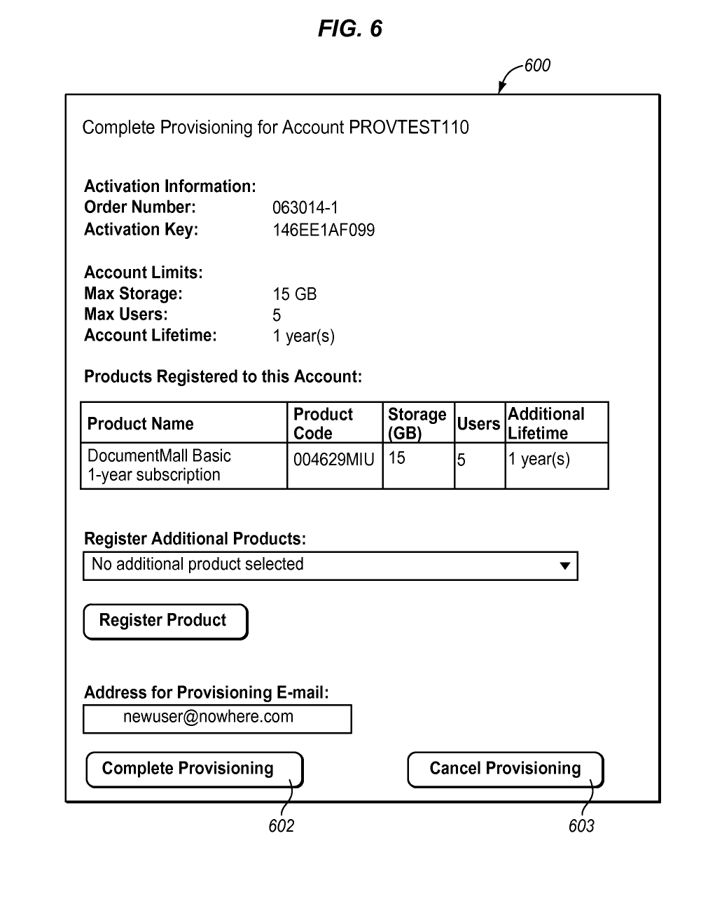

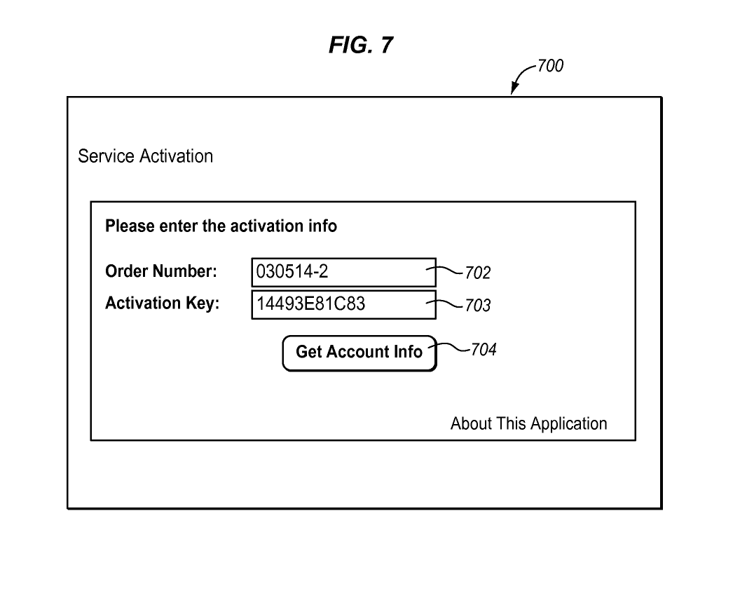

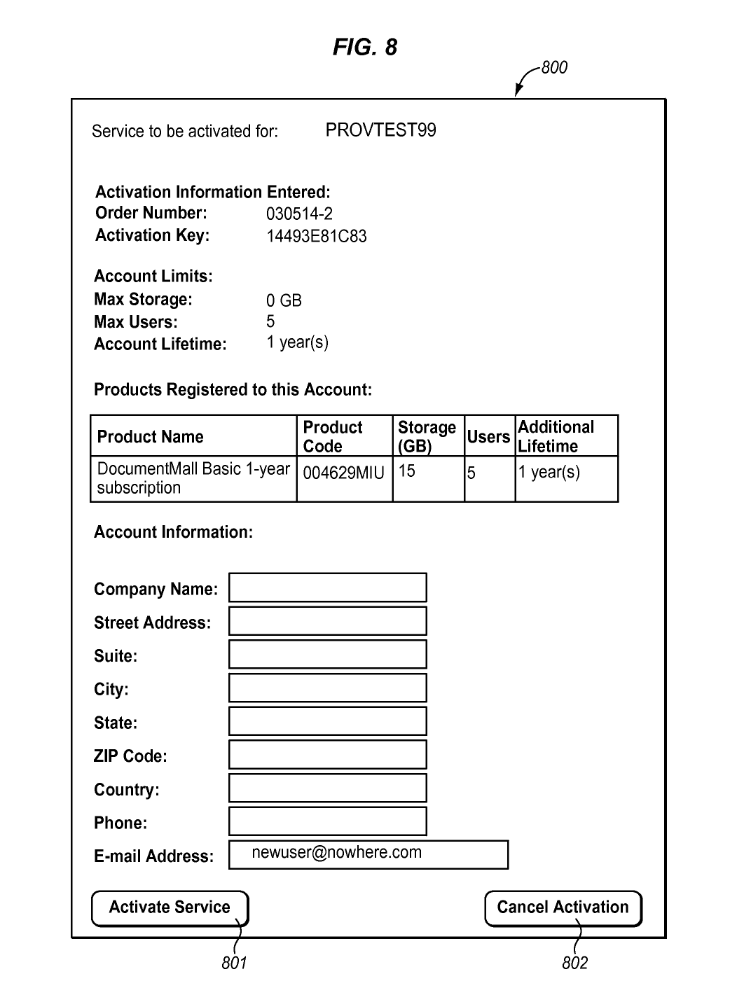

Server 406 receives the information entered by salesperson 408 at web page 500, generates an activation key for the service and provides a second web page 600 (see FIG. 6) to salesperson 408 at terminal 410 for verifying and finalizing the provisioning of the service for user 404. Web page 600 allows salesperson 408 to verify the information previously configured for user 404, review the activation key, and complete the provisioning (e.g., via button 602) or cancel the provisioning (e.g., via button 603). Cancelling the provisioning may occur if salesperson 408 notices an error in the information previously entered in web page 500.

In response to salesperson 408 provisioning the service for user 404, server 406 transmits an email to user 404 at the email address, which includes a link to an activation page, the order number, and the activation key.

In response to receiving the email, user 404 uses a web browser executing on computer 402 to display a web page 700 for activating the service. User 404 enters the order number in a field 702 of web page 700, and enters the activation key in field 703 of web page 700. In some embodiments, user 404 may enter in an account name instead of, or in addition to, the order number. User 404 then selects a button 704 to review the information associated with the account name for user 404.

Server 406 receives the order number and/or the account name, and the activation key entered at web page 700, verifies that the activation key matches the activation key sent to user 404, and provides a web page 800 to user 404 that allows user 404 to review the information and either activate the service (e.g., via button 801) or cancel the activation (e.g., via button 802). In some embodiments, server 404 may verify that the account name entered by user 404 matches the account name configured by salesperson 408, and provide web page 800 to user 404.

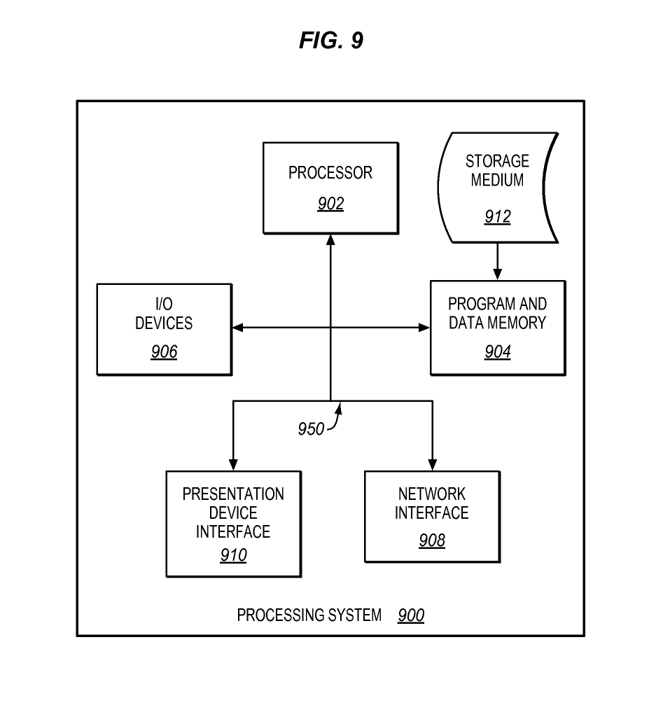

Embodiments disclosed herein can take the form of software, hardware, firmware, or various combinations thereof. FIG. 9 is a block diagram of a processing system configured to execute programmed instructions to perform desired functions in an exemplary embodiment.

Processing system 900 is operable to perform the above operations by executing programmed instructions tangibly embodied on computer readable storage medium 912. In this regard, embodiments of the invention can take the form of a computer program accessible via computer-readable medium 912 providing program code for use by a computer or any other instruction execution system. For the purposes of this description, computer readable storage medium 912 can be anything that can contain or store the program for use by the computer.

Computer readable storage medium 912 can be an electronic, magnetic, optical, electromagnetic, infrared, or semiconductor device. Examples of computer readable storage medium 912 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 900, being suitable for storing and/or executing the program code, includes at least one processor 902 coupled to program and data memory 904 through a system bus 950. Program and data memory 904 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 906 (including but not limited to keyboards, displays, pointing devices, etc.) can be coupled either directly or through intervening I/O controllers. Network adapter interfaces 908 may also be integrated with the system to enable processing system 900 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 910 may be integrated with the system to interface to one or more presentation devices, such as printing systems and displays for presentation of presentation data generated by processor 902.

Although specific embodiments were described herein, the scope of the invention is not limited to those specific embodiments. The scope of the invention is defined by the following claims and any equivalents thereof.

I claim:

1. An apparatus comprising:
a processor of a server that is configured to receive a request to register a document service provided by an online document management system for a user, and to generate an activation code for the service;
the processor configured to identify a web address for activating the service, and to provide the web address and the activation code to the user;
the processor configured to receive a request from a computing device of the user to display a web page for the web address, to provide a first web page to the computing device that includes an entry field requesting the activation code from the user, and to receive the entry via the first web page from the computing device;
the processor configured to determine if the entry matches the activation code for the service, to provide a second web page to the computing device that identifies the service and includes an option to activate the service when the entry matches the activation code, and to notify the user of an error when the entry does not match the activation code;
the processor configured to receive a request via the second web page to activate the service, and to enable the service for the user at the document management system.

2. The apparatus of claim 1 wherein:
the request to register the document service includes an order number for the service requested by the user; and
the processor is configured to provide the first web page to the computing device that includes another entry field requesting the order number from the user, and to receive the other entry via the first web page from the computing device;
the processor configured to determine if the other entry matches the order number for the service, to provide the second web page to the computing device that identifies the requested service and includes an option to activate the service when the other entry matches the order number, and to notify the user of an error when the other entry does not match the order number.

3. The apparatus of claim 1 wherein:
the request to register the document service includes an account name for the user; and
the processor is configured to provide the first web page to the computing device that includes another entry field requesting the account name from the user, and to receive the other entry via the first web page from the computing device;
the processor configured to determine if the other entry matches the account name for the user, to provide the second web page to the computing device that identifies the requested service and includes an option to activate the service when the other entry matches the account name, and to notify the user of an error when the other entry does not match the account name.

4. The apparatus of claim 1 wherein:
the processor, to provide the web address, is configured to transmit an email to the user that includes a Uniform Resource Locator (URL) referencing the web address.

5. The apparatus of claim 1 wherein:
the processor, to provide the web address, is configured to transmit a Short Message Service (SMS) message to the user that includes a Uniform Resource Locator (URL) referencing the web address.

6. The apparatus of claim 1 wherein:
the processor, to receive the request to register the document service, is configured to provide an admin web page to a computing device of an administrator that includes a first entry field requesting a document service to register for the user, and a second entry field requesting an email address of the user;
the processor configured to receive the first entry and the second entry via the admin web page, to generate an email that includes the web address for activating the service requested via the admin web page, and to transmit the email to the email address requested via the admin web page to the user.

7. A method comprising:
receiving a request to register a document service provided by an online document management system for a user;
generating an activation code for the service;
identifying a web address for activating the service;
providing the web address and the activation code to the user;
receiving a request from a computing device of the user to display a web page for the web address;
providing a first web page to the computing device that includes an entry field requesting the activation code from the user;
receiving the entry via the first web page from the computing device;
determining if the entry matches the activation code for the service;
providing a second web page to the computing device that identifies the service and includes an option to activate the service when the entry matches the activation code;
notifying the user of an error when the entry does not match the activation code;
receiving a request via the second web page to activate the service; and
enabling the service for the user at the document management system.

8. The method of claim 7 wherein:
the request to register the document service includes an order number for the service requested by the user;
the first web page includes another entry field requesting the order number from the user; and
the method further comprises:
receiving the other entry via the first web page from the computing device;
determining if the other entry matches the order number for the service;
providing the second web page to the computing device that identifies the requested service and includes an option to activate the service when the other entry matches the order number; and
notifying the user of an error when the other entry does not match the order number.

9. The method of claim 7 wherein:
the request to register the document service includes an account name for the user;
the first web page includes another entry field requesting the account name from the user; and
the method further comprises:
receiving the other entry via the first web page from the computing device;
determining if the other entry matches the account name for the user;
providing the second web page to the computing device that identifies the requested service and includes an option to activate the service when the other entry matches account name; and
notifying the user of an error when the other entry does not match the name.

10. The method of claim 7 wherein providing the web address comprises:
transmitting an email to the user that includes a Uniform Resource Locator (URL) referencing the web address.

11. The method of claim 7 wherein providing the web address comprises:
transmitting a Short Message Service (SMS) message to the user that includes a Uniform Resource Locator (URL) referencing the web address.

12. The method of claim 7 wherein receiving the request to register the document service comprises:
providing an admin web page to a computing device of an administrator that includes a first entry field requesting a document service to register for the user and a second entry field requesting an email address of the user;
receiving the first entry and the second entry via the admin web page generating an email that includes the web address for activating the service requested via the admin web page; and
transmitting the email to the email address requested via the admin web page to the user.

13. A non-transitory computer readable medium embodying instructions which, when executed by a processor of a server, direct the processor to:
receive a request to register a document service provided by an online document management system for a user;
generate an activation code for the service;
identify a web address for activating the service;
provide the web address and the activation code to the user;
receive a request from a computing device of the user to display a web page for the web address;
provide a first web page to the computing device that includes an entry field requesting the activation code from the user;
receive the entry via the first web page from the computing device;
determine if the entry matches the activation code for the service;
provide a second web page to the computing device that identifies the service and includes an option to activate the service when the entry matches the activation code;
notify the user of an error when the entry does not match the activation code;
receive a request via the second web page to activate the service; and
enable the service for the user at the document management system.

14. The non-transitory computer readable medium of claim 12 wherein:
the request to register the document service includes an order number for the service requested by the user;
the first web page includes another entry field requesting the order number from the user; and
the instructions further direct the processor to:
receive the other entry via the first web page from the computing device;
determine if the other entry matches the order number for the service;
provide the second web page to the computing device that identifies the requested service and includes an option to activate the service when the other entry matches the order number; and
notify the user of an error when the other entry does not match the order number.

15. The non-transitory computer readable medium of claim 12 wherein:
the request to register the document service includes an account name for the user;
the first web page includes another entry field requesting the account name from the user; and
the instructions further direct the processor to:
receive the other entry via the first web page from the computing device;
determine if the other entry matches the account name for the user;
provide the second web page to the computing device that identifies the requested service and includes an option to activate the service when the other entry matches account name; and
notify the user of an error when the other entry does not match the name.

16. The non-transitory computer readable medium of claim 12 wherein instructions that direct the processor to provide the web address comprise instructions that direct the processor to:
transmit an email to the user that includes a Uniform Resource Locator (URL) referencing the web address.

17. The non-transitory computer readable medium of claim 12 wherein instructions that direct the processor to provide the web address comprise instructions that direct the processor to:
transmit a Short Message Service (SMS) message to the user that includes a Uniform Resource Locator (URL) referencing the web address.

18. The non-transitory computer readable medium of claim 12 wherein instructions that direct the processor to receive the request to register the document service comprise instructions that direct the processor to:
provide an admin web page to a computing device of an administrator that includes a first entry field requesting a document service to register for the user and a second entry field requesting an email address of the user;
receive the first entry and the second entry via the admin web page generate an email that includes the web address for activating the service requested via the admin web page; and
transmit the email to the email address requested via the admin web page to the user.
